(19) United States
(12) Patent Application Publication
(10) Pub. No.: US 2011/0205384 A1
(43) Pub. Date: Aug. 25, 2011

(54) VARIABLE ACTIVE IMAGE AREA IMAGE SENSOR

(75) Inventors: Jeffrey Jon ZARNOWSKI, McGraw, NY (US); Ketan Vrajlal Karia, Cortland, NY (US); Thomas Poonnen, Cortland, NY (US); Michael Eugene Joyner, McGraw, NY (US)

(73) Assignee: Panavision Imaging, LLC, Homer, NY (US)

(21) Appl. No.: 12/756,932

(22) Filed: Apr. 8, 2010

Related U.S. Application Data
(63) Continuation-in-part of application No. 12/712,146, filed on Feb. 24, 2010.

(51) Int. Cl. H04N 5/335; H04N 5/228

(52) U.S. Cl. 348/222.1; 348/294; 348/E05.091; 348/E05.031

(57) ABSTRACT

Embodiments of the invention provide a variable active image area. Sub-pixels are arranged into a variable selection group, which comprises a pixel group. Sub-pixels of the pixel group can belong to a plurality of selection subgroups. A selector is configured to select a combination of one or more selection subgroups to provide variable sub-pixel selection. Variable sub-pixel selection can vary different aspects of a variable active image area (e.g., location, size, shape). Varying these aspects can lead to greater flexibility in alignment and calibration considerations. Selecting only some of all the sub-pixels can lead to less processing and lower power consumption. A plurality of sub-pixel values can be processed into one pixel group value. Variable sub-pixel selection for different variable selection groups can be independent. Holding circuitry can hold unused or non-selected sub-pixels in a reset condition to reduce blooming.

### CROSS-REFERENCE TO RELATED APPLICATIONS

This is a continuation-in-part (CIP) application of U.S. application Ser. No. 12/712,146, filed on Feb. 24, 2010, the contents of which are incorporated by reference herein in their entirety for all purposes.

### FIELD

Embodiments of the invention relate to image sensors with a variable active image area.

### BACKGROUND

Linear Image Sensors and Area Array Image Sensors

Imaging devices commonly use image sensors to capture images. An image sensor may capture images by converting incident light that carries the image into image capture data. Image sensors may be used in various devices and applications, such as camera phones, digital still cameras, video, biometrics, security, surveillance, machine vision, medical imaging, barcode, touch screens, spectroscopy, optical character recognition, laser triangulation, and position measurement.

One kind of image sensor is a linear image sensor, or a linear imager, as shown by conventional linear image sensor 101 in FIG. 1A. Linear image sensors are often selected for use in applications where the image to be captured is mainly along one axis, e.g., barcode reading or linear positioning. A conventional linear imager 101 may have many (e.g., a few hundred, a few thousand) light detecting elements (LDEs) 103 in a linear arrangement.

Each LDE 103 may convert incident light into an electrical signal (e.g., an amount of electrical charge or an amount of electrical voltage). These electrical signals may correspond to values that are output to readout 105. The values from LDEs in the same row may be read out into readout 105. Readout 105 may then output digital or analog image data to other components for further processing, such as an image processor. Readout 105 may be comprised of a shift register that shifts out the image data at a high rate of speed.

Another kind of image sensor is an area array image sensor, or an area array imager, as shown by conventional area array image sensor 102 in FIG. 1B. Area array image sensors may be employed in applications where it is important to capture two-dimensional aspects of an image, e.g., digital still cameras and video. A conventional area array imager 102 may have many (e.g., hundreds, thousands) rows of LDEs, each row having many (e.g., hundreds, thousands) LDEs 104.

Similar to the readout process for linear imager 101 above, the values from LDEs 104 in the same row of area array imager 102 may be read out into a column readout 106. To read out values from the multiple rows of area array imager 102, a row shifter 108 may shift the readout process through each row of LDEs 104. For instance, values from the first row of LDEs 104 may be read out into column readout 106. Next, column readout 106 may output image data of the first row to other components for further processing (e.g., an image processor), and row shifter 108 may shift the readout process to the second row of LDEs 104. As the readout process progresses through each row, an imaging device may capture image data from the entire face of LDEs 104 of area array imager 102.

Column readout 106 may be comprised of a shift register or other logic that shifts out the image data at a high rate of speed. Row shifter 108 may also be comprised of a shift register or other logic for advancing the readout process to the next row.

For each image capture, the LDEs of an image sensor may produce a corresponding frame of data. Compared to a conventional area array imager, a conventional linear imager may produce much less data per image capture frame. Processing the data of an image captured by the linear imager may involve much less computation than processing the data of an image captured by the area array imager. For example, a linear imager with one row of 480 LDEs may produce 480 data samples per frame of image capture data. In contrast, an area array imager for low resolution VGA with 480 rows of 640 LDEs per row may produce 640×480=307,200 data samples per frame of image capture data. Clearly, processing the image capture data from the linear imager may involve much less processing power then processing the image capture data from the area array imager.

As a conventional linear imager may have much fewer LDEs than a conventional area array imager, the linear imager may have lower power consumption. Additionally, processing the relatively smaller amounts of data from the linear imager may lead to fewer computations, which may lead to even lower power consumption.

Also, with a fewer number of LDEs to occupy physical space, the size of the circuit die for a conventional linear imager may be much smaller. This smaller size may lead to comparatively lower production costs for the linear imager.

Thus, compared to a system design using an area array imager, a system design using a linear imager may provide lower power consumption, lower production costs, and smaller size. Such relative advantages may be based on the relatively low count of LDEs of the linear imager.

Alignment for Image Sensors

Alignment is a common concern in applications for linear imagers. Without proper alignment, an entire application may fail, regardless of the quality of the linear image sensor employed. Proper alignment of the linear arrangement of LDEs of a conventional linear imager to the desired image capture field within suitable margins of alignment tolerance can be difficult to achieve and maintain. For example, the active image area of a linear image sensor may be long and thin, and the margin of alignment tolerance for the thin aspect ratio may be very narrow when the linear image sensor is first assembled in an image capture device. If assembly of the image capture device fails to achieve proper alignment within the suitable tolerance margins, the image capture device may be unusable. An assembly system that produces a high rate of unusable devices may have low assembly yield.

Additionally, the alignment of the linear image sensor may change due to common physical movement of the sensor through common physical usage of the image capture device. Correcting the alignment may involve costs in repairs or replacements.

Additionally, an image capture device may comprise multiple components in addition to the linear imager, such as optical elements (e.g., lenses, reflectors, prisms). Proper usage of such additional components may also involve precisely aligning these additional components with the linear imager and the desired image capture field. All of these components may have to be aligned within certain margins of alignment tolerances, as well. Difficulties in properly aligning all of these components together may lead to difficulties in the assembly of the image capture device.

For example, a linear imager with a row of 2000 LDEs, each light detecting element with dimensions of 10×10 microns, may have an image area of 20 millimeters×10 microns. It can be very difficult to achieve and maintain the proper optical arrangement for aligning the long, thin active image area of the linear imager to the desired image capture field. Although it may be possible to assemble and construct devices with sufficiently narrow margins of tolerance, costs associated with these narrow margins may be high in various ways, such as costs in production, maintenance, calibration, alignment, repair, and replacement.

Furthermore, as the effect of alignment adjustments can be magnified with increasing distances, even narrower margins of alignment tolerance may be required in applications where relatively large distances are involved. For an examplary linear image sensor image area of 20 millimeters×10 microns, if the image to be captured is scores of centimeters or even meters away from the linear image sensor, alignment tolerances may have to be within only a few microns.

Even if the image capture device is properly aligned, the desired image may change in ways that can introduce additional issues. For example, the shape and/or position of the desired image may change so that desired image does not fall within the image capture field. That is, the desired image would not be aligned with the image capture field of the image capture device. Such changes in the desired image may be caused by environmental changes. For example, changes in the environment temperature may cause mechanical components to expand or contract, which may affect the optical alignment between the desired image and the image capture field.

One technique for easing alignment tolerances is using an LDE with very tall dimensions. For example, instead of square dimensions of 8 microns×8 microns, one may use very tall dimensions of 125 microns×8 microns. The tall LDEs may collect light from a much greater area, so the larger dimensions may enable greater alignment tolerances and increased sensitivity. However, although greater amounts of light may be collected, much of this collected light may be undesired for the particular application. Such extra light may contribute to unfavorable effects, such as extra noise in the form of unwanted signals.

Another technique may involve digital binning of multiple LDEs. Instead of employing a single LDE with tall physical dimensions and a tall active image area, one may digitally bin together multiple LDEs with smaller physical dimensions to form an effective active image area that matches the tall active image area. Image capture data samples may be readout from each of the binned LDEs and then digitally processed to obtain the desired image capture information. However, the digital processing may add noise and lower the signal-to-noise ratio. Also, similar to using LDEs with tall physical dimensions, the extra light collected may contribute to unfavorable effects. Furthermore, the additional LDEs for digital binning may increase the data samples and the corresponding computations for digitally processing the data samples. Moreover, the effective active image area of the digitally binned LDEs may still be fixed in size and location. Therefore, addressing the alignment needs of a specific application may still require highly precise arrangement of LDEs of specific LDE size. Digital binning may be exemplified by the DLIS 2K imager from Panavision Imaging LLC.

FIG. 2A illustrates an image properly aligned with a conventional linear image sensor. In FIG. 2A, image 205 represents an image to be captured. When the image to be captured is mainly along one axis, a relatively small range of alignment positions may be suitable for a conventional linear imager 201. FIG. 2B illustrates an image not properly aligned with a conventional linear image sensor. Without proper alignment, linear imager 201 may not suitably capture image 205, as exemplified in FIG. 2B.

In contrast to linear imagers, alignment may often be a lesser concern in applications for area array imagers. FIG. 2C illustrates an image within the active image area of a conventional area array image sensor. Compared to the long, thin active image area of linear imager 205, the active image area of a conventional area array imager 202 may be similar in length but much taller in height by many orders of magnitude. Accordingly, the larger active image area of the area array imager allows a greater range of suitable alignment positions for capturing the same image 205 with the area array imager 202.

Thus, there may be a tradeoff between image capture options. Using a linear imager instead of an area array imager may involve less processing power, lower power consumption, lower production costs, and smaller size. However, using a linear imager may also involve greater alignment concerns and associated costs. An image sensor with the benefits of both a linear imager and an area array imager could enable devices and applications with low system costs.

### SUMMARY

Embodiments of the invention provide a variable active image area. Sub-pixels are arranged into a variable selection group, which includes a pixel group. Sub-pixels of the pixel group can belong to a plurality of selection subgroups. A selector is configured to select a combination of one or more selection subgroups to provide variable sub-pixel selection. Variable sub-pixel selection can vary different aspects of a variable active image area (e.g., location, size, shape). Varying these aspects can lead to greater flexibility in alignment and calibration considerations. Selecting only some of all the sub-pixels can lead to less processing and lower power consumption.

The pixel group can output one pixel group value per selected combination. A readout can read out the one pixel group value. The one pixel group value may be based on a plurality of sub-pixel values generated by a plurality of sub-pixels. Processing the plurality of sub-pixel values into one pixel group value may lead to less processing and lower power consumption.

A variable selection group can comprise two pixel groups. A selection subgroup may include a sub-pixel from each of these two pixel groups. If this selection subgroup is selected, the included sub-pixels may also be selected. Thus, multiple sub-pixels can be selected by selecting just one selection subgroup.

Embodiments of the invention can include two variable selection groups. Variable sub-pixel selection for one variable selection group can be independent of variable sub-pixel selection for the other variables selection group. Therefore, a wide variety of active image area selection configurations is possible.

Binning circuitry can bin together a plurality of sub-pixels within a pixel group, either through analog or digital binning. An analog embodiment can include a sense node and each sub-pixel of the pixel group including a photodetector and a selection gate configured to connect the photodetector to the sense node. An analog embodiment may reduce digital processing.

Holding circuitry can hold unused or non-selected sub-pixels in a reset condition. These unused or non-selected sub-pixels can belong to a set of selection subgroups other than the one or more selection subgroups of the selected combination. This holding circuitry can minimizing crosstalk between neighboring sub-pixels related to blooming. Low or no blooming may lead to better image quality. An embodiment can include a bias source and a selection subgroup bias gate configured to connect the bias source to a selection subgroup. Each unused or non-selected sub-pixel belonging to the selection subgroup can include an unused or non-selected photodetector and a sub-pixel bias gate configured to connect the unused or non-selected photodetector to the bias source.

### BRIEF DESCRIPTION OF THE DRAWINGS

FIG. 1A illustrates a conventional linear image sensor.

FIG. 1B illustrates a conventional area array image sensor.

FIG. 2A illustrates an image properly aligned with a conventional linear image sensor.

FIG. 2B illustrates an image not properly aligned with a conventional linear image sensor.

FIG. 2C illustrates an image within the active image area of a conventional area array image sensor.

FIG. 3A illustrates an exemplary variable active image area image sensor and related components according to embodiments of the invention.

FIG. 3B illustrates details of an exemplary variable selection group of an exemplary variable active image area image sensor according to embodiments of the invention.

FIG. 3C illustrates an embodiment of a variable selection group with 50 sub-pixels arranged into 10 pixel groups and 5 selection subgroups.

FIG. 4A illustrates an exemplary active image area selection configuration of an image sensor face according to embodiments of the invention.

FIG. 4B illustrates some variations in active image area selection configurations using six variable selection groups according to embodiments of the invention.

FIG. 5 illustrates an exemplary image capture device including a sensor (imager) according to embodiments of the invention.

FIG. 6 illustrates a hardware block diagram of an exemplary image processor that can be used with a sensor (imager) according to embodiments of the invention.

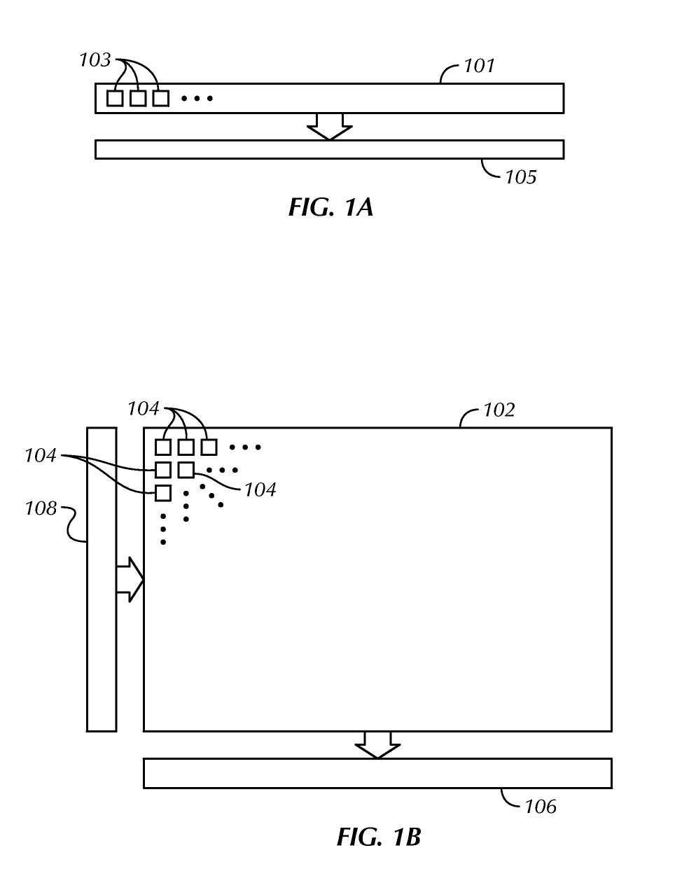

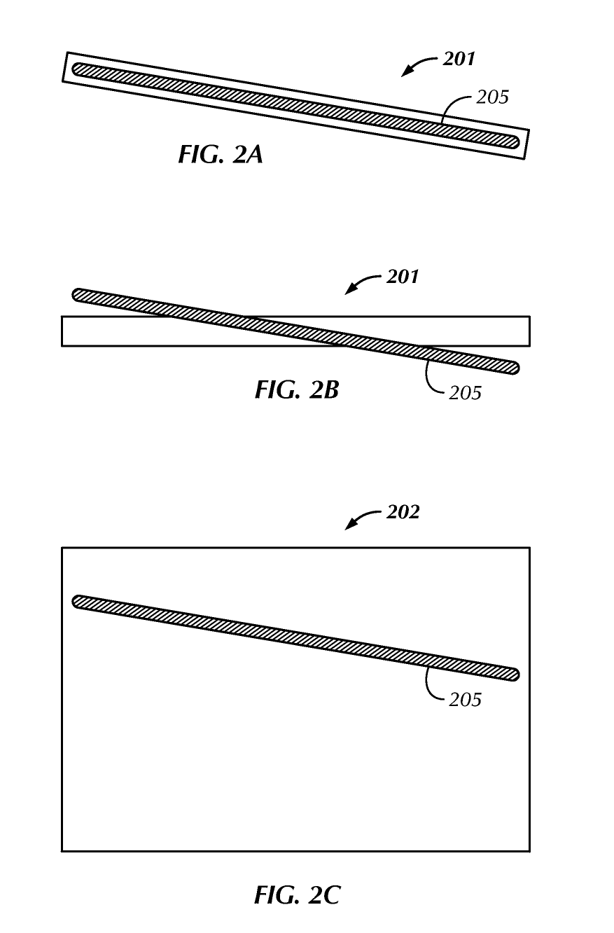

### DETAILED DESCRIPTION

In the following description of preferred embodiments, reference is made to the accompanying drawings which form a part hereof, and in which it is shown by way of illustration specific embodiments in which the invention can be practiced. It is to be understood that other embodiments can be used and structural changes can be made without departing from the scope of the embodiments of this invention.

Variable Active Image Area Imager and Related Components

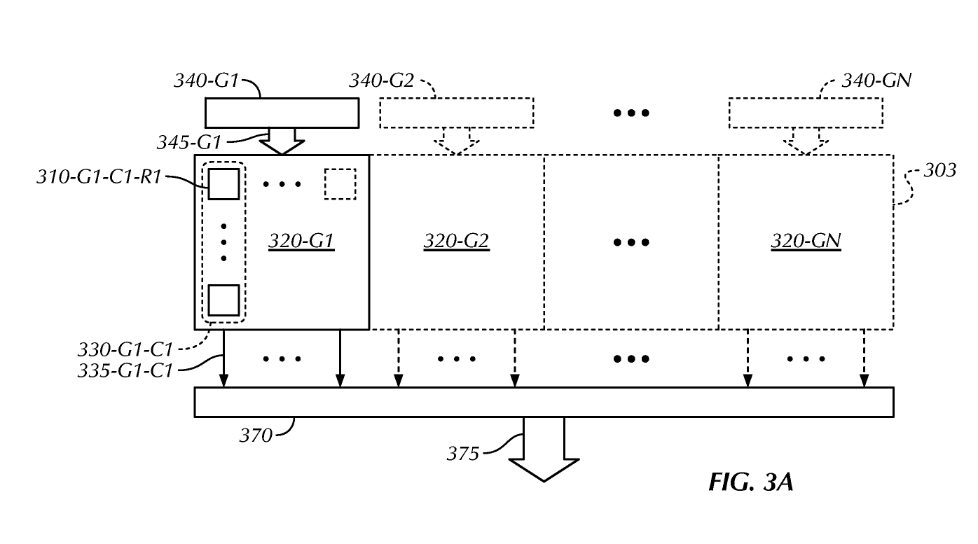

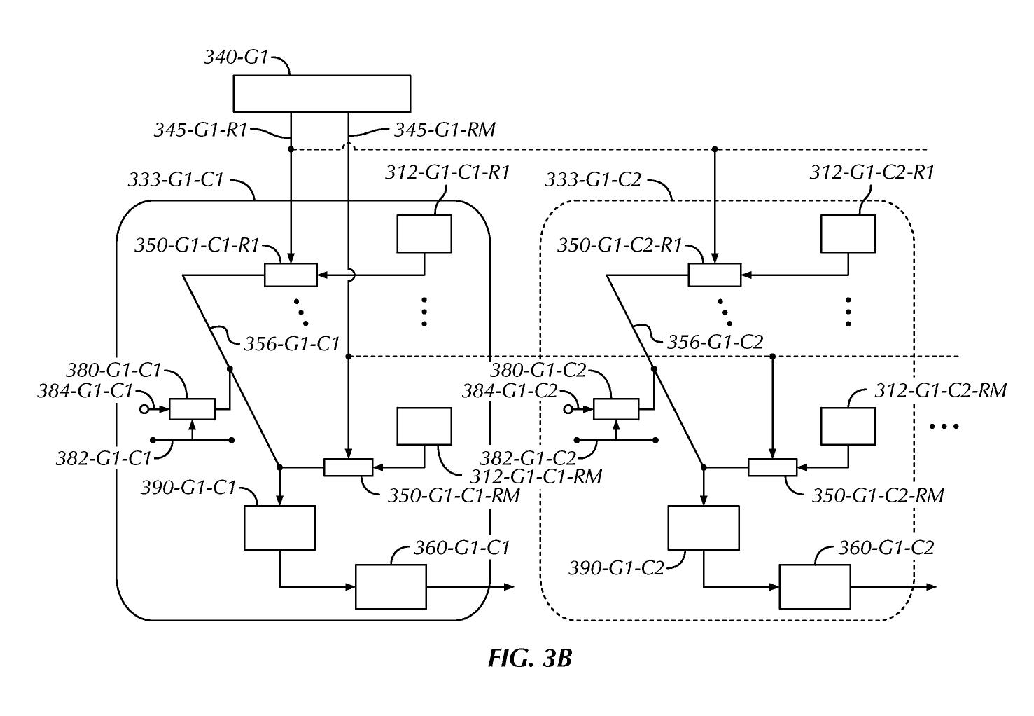

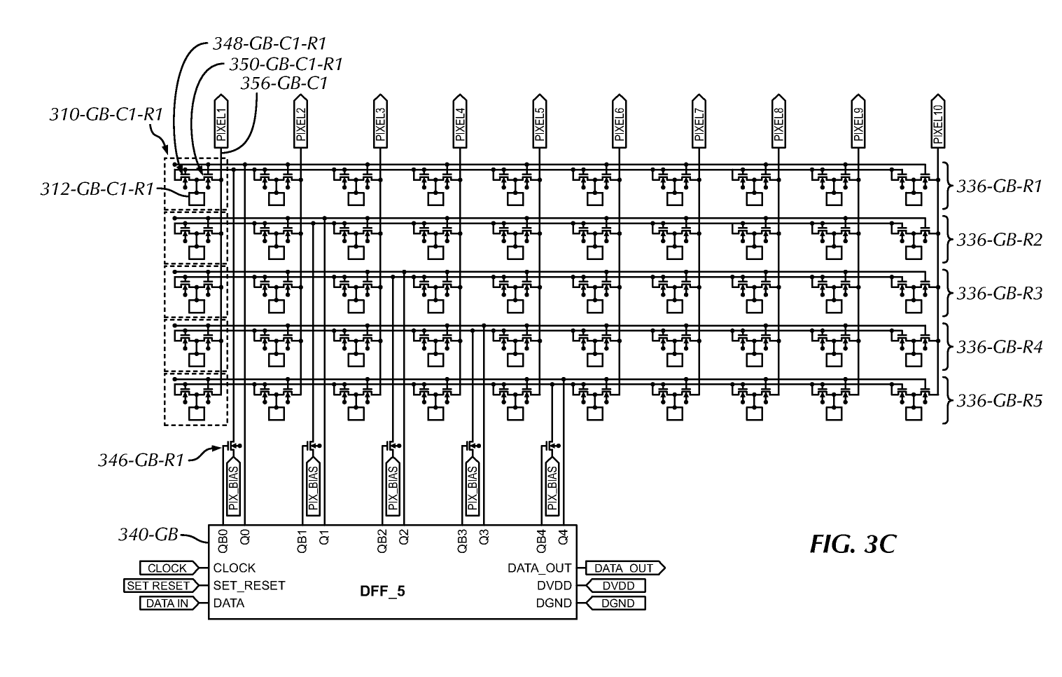

FIG. 3A illustrates an exemplary variable active image area image sensor and related components according to embodiments of the invention. A variable active image area image sensor according to embodiments of the invention may be used in various devices and applications, such as camera phones, digital still cameras, video, biometrics, security, surveillance, machine vision, medical imaging, barcode, touch screens, spectroscopy, optical character recognition, laser triangulation, and position measurement

A variable active image area imager may comprise an image sensor with a linear shape and multiple rows of LDEs, as shown by variable active image area image sensor 303 in FIG. 3A. As an example, variable active image area imager 303 may comprise 2-20 rows and around 1000 columns of LDEs, or “sub-pixels.” Other embodiments may include an image sensor with a different shape, such as a square, rectangle, circle, or oval.

The sub-pixels may be divided into one or more groups 320-G1, 320-G2, . . . , 320-GN for variable selection. Variable selection group 320-G1 represents an exemplary Group 1. Each variable selection group may comprise one or more pixel groups. A pixel group may be arranged as a row, a column, a diagonal, or any other arbitrary arrangement of sub-pixels, according to application needs. For instance, column 330-G1-C1 represents an exemplary pixel group in a column arrangement at position Group 1-Column 1.

Sub-pixel 310-G1-C1-R1 represents an exemplary sub-pixel (comprising a photodetector, e.g., a photodiode, a photogate) at position Group 1-Column 1-Row 1. Sub-pixel 310-G1-C1-R1 may be sensitive to light in various ranges of the electromagnetic spectrum. One example is the infrared region, e.g., 700-900 nm. Other examples include one or more specific color regions, e.g., one or more of red, yellow, green, blue, and violet. Another example is the ultraviolet region, e.g., 100-400 nm. Sub-pixels may also be monochrome. Still other examples may include wavelength ranges beyond those mentioned here. In other words, embodiments of the invention may be independent of any particular wavelength range for sub-pixels.

Additionally, embodiments of the invention may be independent of specific types of sub-pixels and image sensor architecture. For example, an exemplary sub-pixel may belong to the Active Pixel Sensor type, as exemplified in U.S. Pat. No. 5,949,483 to Fossum et al. For another example, an exemplary sub-pixel may belong to the Active Column Sensor type, as exemplified in U.S. Pat. No. 6,084,229 to Pace et al.

For each variable selection group, there may be a corresponding selector, as exemplified by selector 340-G1 for Group 1. (Selector 340-G2 would correspond to group 320-G2, and selector 340-GN would correspond to group 320-GN.) Selector 340-G1 may select a combination of one or more selection subgroups of sub-pixels in group 320-G1 through output 345-G1. A selection subgroup may be arranged as a row, a column, a diagonal, or any other arbitrary arrangement. For instance, the first row of sub-pixels in group 320-G1 (e.g., including sub-pixels 310-G1-C1-R1 and 310-G1-C2-R1) may be characterized as an exemplary selection subgroup in a row arrangement at position Group 1-Row 1.

Furthermore, selector 340-G1 can be configured to select any combination of one or more selection subgroups of sub-pixels in group 320-G1 through output 345-G1. For example, in the case of three selection subgroups arranged as Rows 1, 2, and 3, selector 340-G1 can be configured to select any combination of one or more of these three selection subgroups: {Row 1}, {Row 2}, {Row 3}, {Row 1, Row 2}, {Row 1, Row 3}, {Row 2, Row 3}, {Row 1, Row 2, Row 3}.

Every column in group 320-G1 may have the same selected one or more rows. In column 330-G1-C1, a sub-pixel in a selected row may produce output for column 330-G1-C1. If there is more than one selected row, sub-pixels of the selected rows would be selected to produce output for column 330-G1-C1. Output for column 330-G1-C1 may be incorporated into an input 335-G1-C1 into a readout 370. Values 375 corresponding to image capture data may be output from readout 370 for processing, e.g., image processing. Readout 370 may comprise a memory element, such as a shift register. Alternatively, readout 370 may comprise random access logic or a combination of shift register logic and random access logic.

Variable Selection Group

FIG. 3B illustrates details of an exemplary variable selection group (e.g., 320-G1) of an exemplary variable active image area image sensor according to embodiments of the invention. For clarity, other component details of group 320-G1 have not been included in FIG. 3B.

Group 320-G1 may comprise one or more sets of circuitry associated with corresponding pixel groups of sub-pixels. Each pixel group of variable selection group 320-G1 may have a corresponding pixel group circuit. For example, pixel group circuit 333-G1-C1 represents circuitry associated with the exemplary pixel group arranged in a column at position Group 1-Column 1. For each additional pixel group, group 320-G1 may comprise another pixel group circuit, such as 333-G1-C2 for Group 1-Column 2.

In addition to variable row selection group 320-G1, groups 320-G2 to 320-GN may be similar, or even identical, to group 320-G1 with corresponding reference characters with G2 to GN for Groups 2 to N. Each group 320-G1 to 320-GN may have the same number of columns per group or each group 320-G1 to 320-GN may have different numbers of columns. Each group 320-G1 to 320-GN may have the same number of rows per group or each group 320-G1 to 320-GN may have different numbers of rows.

In group 320-G1, each column may comprise M rows of sub-pixel photodetectors. For Group 1-Column 1, there are sub-pixel photodetectors 312-G1-C1-R1 to 312-G1-C1-RM. For each sub-pixel photodetector, there may be a selection gate. A selection gate may be any suitable gating element (e.g., a field-effect transistor (FET), a transmission gate). Selector 340-G1 may send a control signal 345-G1-R1 to selection gate 350-G1-C1-R1 for selecting a sub-pixel of a selection subgroup. For instance, sub-pixel 310-G1-C1-R1 in FIG. 3A represents a sub-pixel of an exemplary selection subgroup at position Group 1-Row 1. Selector 340-G1 may send a control signal 345-G1-RM to selection gate 350-G1-C1-RM for selecting Row M. Each column may have the same number of rows, or different columns may have different numbers of rows.

Incident light that carries a desired image may be converted into image capture data values through the following exemplary process. Light incident onto sub-pixel 312-G1-C1-R1 may be converted into an electrical signal, which may be output to selection gate 350-G1-C1-R1. Control signal 345-G1-R1 may control selection gate 350-G1-C1-R1 to place a corresponding electrical signal onto a common sense node 356-G1-C1. The electrical signal may be processed through the cooperation of reset switch 380-G1-C1, reset line signal 382-G1-C1, reset bias 384-G1-C1, sense circuitry 390-G1-C1, and capture circuitry 360-G1-C1.

Sense circuitry 390-G1-C1 may generate an output representative of the total electrical signal on the sense node 356-G1-C1. Sense circuitry 390-G1-C1 may be embodied in multiple variations. An exemplary embodiment may comprise a sense FET connected to sense node 356-G1-C1, the sense FET also connected to an amplifier that outputs an analog value for analog binning. Another exemplary embodiment may comprise an op-amp connected to sense node 356-G1-C1, the op-amp configured into an applicable op-amp configuration (e.g., comparator, integrator, gain amplifier) that outputs a digital value for digital binning.

The output of sense circuitry 390-G1-C1 can then be captured by capture circuitry 360-G1-C1. In the case that sense circuitry 390-G1-C1 outputs an analog value, capture circuitry 360-G1-C1 can include an analog-to-digital converter (ADC) that digitizes the output of sense circuitry 390-G1-C1. In the analog case, an analog value can be switched onto bus(es) for further processing or readout. In the digital case, a value representative of the total electrical signal can then be determined and stored in a memory element (e.g., a latch, an accumulator). This value can be read out for processing, e.g., image processing. In one embodiment, capture circuitry 360-G1-C1 may provide input 335-G1-C1 into readout 370 of FIG. 3A. In another embodiment, capture circuitry 360-G1-C1 may be part of readout 370.

Data from pixel group circuit 333-G1-C1 may be understood as “pixel” data. In the case that only one row is selected, common sense node 356-G1-C1 may have a total electrical signal corresponding to one sub-pixel. In this case, one sub-pixel may be understood as the size of the “pixel” data.

In the case that multiple rows are selected at the same time (e.g., three rows), common sense node 356-G1-C1 may have a total electrical signal corresponding to multiple sub-pixels (e.g., three sub-pixels). Binning may be understood as reading out more than one sub-pixel at a time. If multiple sub-pixels (e.g., three) are selected, the number of sub-pixels may be understood as the size of the “pixel” data from pixel group circuit 333-G1-C1. If multiple non-adjacent sub-pixels are selected (e.g., a set of 1 sub-pixel non-adjacent to another set of 2 adjacent sub-pixels), “pixel” data from pixel group circuit 333-G1-C1 may be understood as incorporating image information from non-adjacent portions of the corresponding column. Additional teachings concerning binning may be found in U.S. Pat. No. 7,057,150 B2 to Zarnowski et al.

When a set of sub-pixels is selected in a column (i.e., one or more sub-pixels), this set may be understood as a “pixel” of the column. The size of this pixel would be based on the number of sub-pixels in the set. The location of this pixel would be based on the location of selected row(s) in the column. Additionally, even if the set consists of two non-adjacent sub-pixels, one may still consider such a set as a pixel.

In addition to pixel group circuit 333-G1-C1, group 320-G1 may comprise additional sets of pixel group circuits, exemplified by pixel group circuit 333-G1-C2. Pixel group circuit 333-G1-C2 may be similar, or even identical, to pixel group circuit 333-G1-C1 with corresponding reference characters with C2 for Column 2.

Within the same variable selection group (e.g., 350-G1), all the pixel group circuits (e.g., 333-G1-C1, 333-G1-C2, etc.) may receive the same control signals (e.g., 345-G1-R1 to 345-G1-RM) from the same selector (e.g., 340-G1). Therefore, a selection subgroup (e.g., row selection) could be the same for all the pixel groups (e.g., columns) in the same variable selection group. In an example embodiment of group 320-G1 with 5 rows and 10 columns, if selector 340-G1 selects Rows 2-4, group 320-G1 may have an active image area of a block of 30 sub-pixels (3 rows of sub-pixels×10 columns of sub-pixels=30 sub-pixels).

In embodiments with a plurality of variable selection groups, the sub-pixel selection for one variable selection group may be independent of the sub-pixel selection for another variable selection group. For example, the control signals provided by selector 340-G1 may be independent of the control signals provided by selector 340-G2.

In the previous disclosure of U.S. patent application Ser. No. 12/712,146 filed Feb. 24, 2010, sub-pixels have been described as LDEs that can be binned together to form a larger pixel prior to readout. The process of binning the sub-pixels may effectively control the size of the pixel to be readout. If the desired pixel size is larger than a single sub-pixel, then binning can be utilized. The selection of binned sub-pixels in a pixel group may also control the location of a pixel. Only the sub-pixels aligned in position to the desired image may need to be readout.

During the design phase, a pixel group may be constructed to have multiple sub-pixels. The minimum sub-pixel size may be set to fit the application need or set smaller to allow for finer positioning of selected sub-pixels. If sub-pixel binning is not desired for the application, then a value of only a single sub-pixel may be read out from a pixel group. Calibration may be performed to fine tune the selection of sub-pixels according to which sub-pixels may be most closely aligned to the desired image. Such calibration may be performed during assembly or at any time after assembly.

FIG. 3C illustrates an embodiment of a variable selection group with 50 sub-pixels arranged into 10 pixel groups and 5 selection subgroups. The variable selection group forms a block of sub-pixels. The pixel groups are arranged into 10 columns of sub-pixels. The selection sub-groups are arranged into 5 rows of sub-pixels. The physical size of the group can be of any size according to application preferences.

Sub-pixel 310-GB-C1-R1 represents an exemplary sub-pixel in the group block at position Column 1-Row 1. Sub-pixel 310-GB-C1-R1 may comprise a FET as selection gate 350-GB-C1-R1.

If selected by DFF output Q0 from selector 340-GB, selection gate 350-GB-C1-R1 connects photodiode 312-GB-C1-R1 to sense node 356-GB-C1. In this embodiment, a sub-pixel may be selected if the DFF output Q0 to the gate of FET 350-GB-C1-R1 is “high” or a digital “1,” thus photodiode 312-GB-C1-R1 would be connected to sense node 356-GB-C1. Sense node 356-GB-C1 can be connected to sense circuitry (e.g., a buffering amplifier as a source follower, an input FET of an operational amplifier).

It can be seen that an enabled output of DFF-Q0 would select all the sub-pixels of row 336-GB-R1 throughout their respective columns. In the same manner, an enabled output of DFF-Q1 would select all the sub-pixels of row 336-GB-R2 throughout their respective columns. Therefore, a combination of one or more rows of sub-pixels can be selected based on DFF output Q0-Q4. Furthermore, any combination of one or more rows can be selected based on DFF output Q0-Q4. Image capture information from each selected sub-pixel would transfer to the sense node of the corresponding column of the sub-pixel.

The selector 340-GB DFF block can be a shift register, as shown in FIG. 3C. Selector 340-GB comprises 5 serially connected D flip-flops. Other configurations are possible where the information indicating the selected sub-pixels can be held and stored until such information is reset or reprogrammed.

The following description provides timing information for operating the embodiment of FIG. 3C. 5 clock cycles can be used to program the 5 serial flip-flops. To select row 336-GB-R5, DATA_IN may be “1” for DFF clock cycle 1 and followed by “0” for DFF clock cycles 2-5. DFF outputs Q0-Q4 would be 00001, selecting only row 336-GB-R5. Afterwards, the values on the all the column sense nodes would be read out, and these values would correspond to the values of selected row 336-GB-R5. For other examples, DFF outputs Q0-Q4 as 01100 could select rows 336-GB-R2, R3; and DFF outputs Q0-Q4 as 10110 could select rows 336-GB-R1, R3, R4.

Referring back to FIG. 3C, DFF outputs QB can also provide a useful feature, such as minimizing crosstalk between neighboring sub-pixels related to blooming. As a photodiode converts incident light photons into electrical charge, the photodiode may saturate. Once the photodiode has been saturated, charge may spill over to neighboring photodiodes. This spillover may be known as blooming.

The QB output of the flip-flops can be used to hold the non-selected sub-pixels in a reset condition. For example, a FET can be used as row bias gate 346-GB-R1 to connect a bias to the sub-pixels of row 336-GB-R1. In the case that row 336-GB-R1 is not selected for readout, Q1 may be “low” or “0,” and QB1 may be “high” or “1.” The gate of FET 346-GB-R1 would be “high” or “1” and be on. The PIX_BIAS value would be put on sub-pixel bias gate 348-GB-C1-R1. Specifically, the PIX_BIAS value would be put on the gate and drain of FET 348-GB-C1-R1, connecting the PIX_BIAS onto photodiode 312-GB-C1-R1.

Even if sub-pixel 310-GB-C1-R1 is not selected for readout, its photodiode 312-GB-C1-R1 may still convert incident light photons into electrical charge. PIX_BIAS could hold the value of photodiode 312-GB-C1-R1 to a particular reference value to prevent the photodiode from collecting photon-generated charge. The charge that is generated on non-selected sub-pixel 310-GB-C1-R1 could be drained off through PIX_BIAS. Thus, charge would not fill photodiode 312-GB-C1-R1 and would not spill over into neighboring sub-pixels, thereby preventing or minimizing blooming. Otherwise, blooming may lead to a nearby selected photodiode picking up unwanted charge from non-selected photodiode 312-GB-C1-R1. Such unwanted charge could adversely affect the image capture information provided by the selected photodiode, thus reducing image quality. Accordingly, low or no blooming may lead to better image quality.

Active Image Area Selection Configurations

Based on the teachings above, the sub-pixels of an image sensor can be selected so that the active image area of the image sensor can be configured into a wide variety of arrangements. For each variable selection group, a selector may send control signals to select sub-pixels in the group that would form part of the active image area. In between image captures, a selector may alter its selection of sub-pixels so that a different active image area selection configuration can be used for each image capture.

In some embodiments, sub-pixels may be selected according to addressing techniques. For example, a sub-pixel may have its own unique address. With addressing techniques, a selector can receive address information and then send control signals to selection gates based on the received address information.

In some embodiments, sub-pixels may be selected according to position information. For example, a selector for a variable selection group (e.g., selector 340-G2 for group 320-G2) can simply receive row selection information (e.g., selection of Rows 2-5), and then send control signals to select sub-pixels based on the row selection information (e.g., all the sub-pixels in Rows 2-5 for all columns in group 320-G2).

A selector may be simple and comprise just a memory element, such as a shift register comprising flip-flops. As an example, a simple string of values held by flip-flops of the shift register may indicate the row selection for all the columns in a variable selection group. In some embodiments, the number of flip-flops in a selector may equal the number of rows (i.e., the number of elements in a pixel group) in the corresponding variable selection group.

The shift registers could be programmed using a Data_In input, a clock, and an optional reset. Flip-flops are small and could easily fit within a narrow space (e.g., within 20 microns) along the edge of an image sensor face. Such a narrow space may barely increase the die size.

A selector may comprise other components (e.g., a processor, additional logic) that can receive address or position information of selected sub-pixels in various forms and then process this information to produce suitable control signals to select the corresponding sub-pixels.

A selector may receive sub-pixel selection information from another controlling component or the selector may be part of a larger controlling component that produces sub-pixel selection information.

An exemplary active image area selection configuration may be linear. A linear configuration may be useful for capturing a linear image. For capturing a linear image, the selected sub-pixels may be mainly along one linear axis. However, it would not be required for these sub-pixels to be aligned along a horizontal axis, i.e., a particular row of sub-pixels. That is, instead of employing conventional measures of physically aligning a linear image and the physical dimensions of the image sensor face to have a particular alignment (e.g., a specific parallel alignment), the active image area of an image sensor can be configured to closely match the linear image.

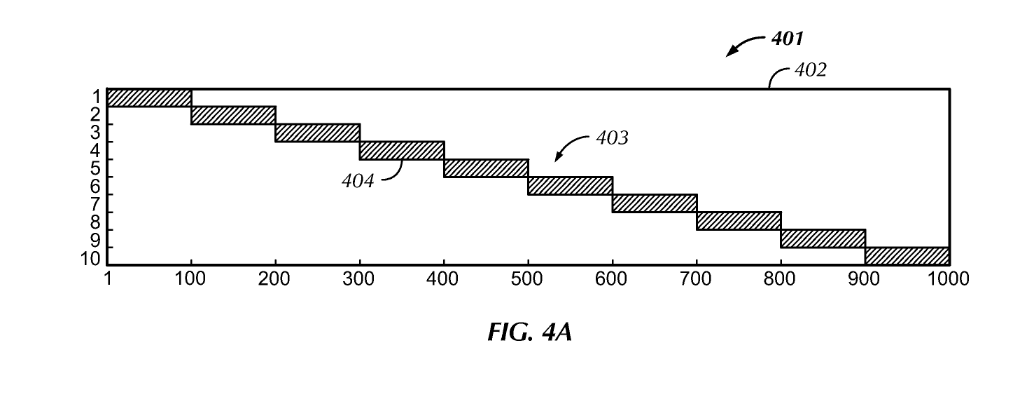

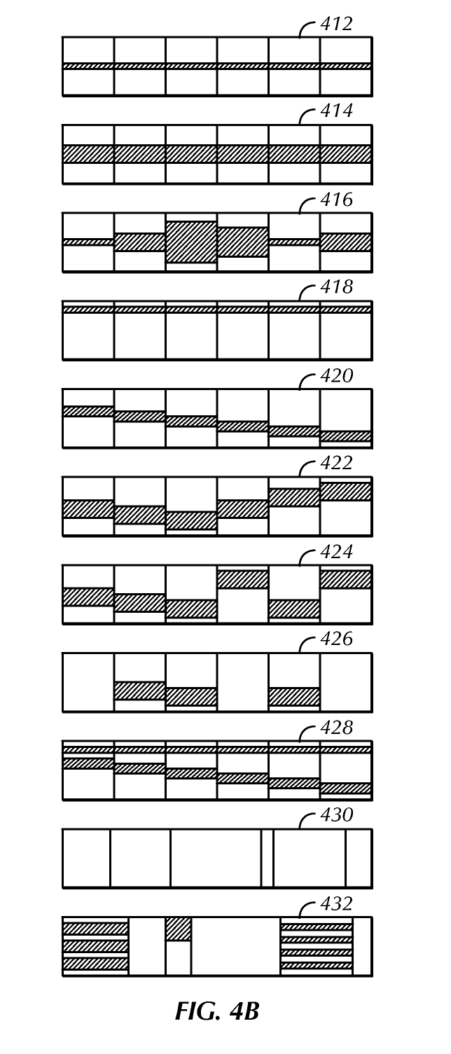

FIG. 4A illustrates an exemplary active image area selection configuration (e.g., 401) of an image sensor face (e.g., 402) according to embodiments of the invention. FIG. 4A is intended to show principles related to embodiments of the invention and may not be drawn to exact scale. Face 402 may have 10 rows and 1000 columns of sub-pixels. Each sub-pixel may have dimensions of 10×10 microns so that face 402 may have boundary dimensions of 100 microns×10 mm. Configuration 401 may be useful for capturing a linear image that has an alignment with respect to image sensor face 402 that is not parallel (e.g., diagonal).

A desired linear image may start at the sub-pixel located at position Row 1-Column 1 at the top left of face 402 and continue down to an the maximum angle to the sub-pixel located at position Row 10-Column 1000 at the bottom right of face 402. Configuration 401 with an active image area 403 may capture such a desired linear image. As this desired linear image may shift only one row every 100 columns, configuration 401 may employ only 10 variable selection groups (1000 total columns/100 columns per shift=10 variable selection groups for shifting). For each variable selection group, a selector may control the location, size, and shape of the portion of the active image area (e.g., 404) in the variable selection group.

If face 402 is divided into 10 variable selection groups, it may be sufficient to have only 10 sets of row selection information (one set for each variable selection group) instead of 1000 sets of row selection information (one set for each column). In other words, it may sufficient to have distinct row selection information for every 100 columns. Therefore, the requirements for row selection information may be greatly simplified. For example, only 10 distinct addresses may be sufficient to provide an active image area selection configuration that is aligned to the entire desired linear image.

If face 402 is divided into more than 10 variable selection groups (e.g., 20 variable selection groups of 50 columns each), greater alignment flexibility may be provided. For example, a desired linear image may not span across all 1000 columns when the image is aligned at a steep angle across face 402. In this case, it may be unnecessary to use image information from all the variable selection groups, and finer resolution may provide closer alignment between the steeply angled image and the selected sub-pixels.

In some embodiments where a selector comprises flip-flops, consider an example of 20 variable selection groups, each group having 10 rows and 50 columns of sub-pixels. For each variable selection group, a selector may comprise 10 flip-flops (i.e., one flip-flop per row). In total, the corresponding selectors would employ 200 flip-flops (i.e., 10 flip-flops×20 variable selection groups).

A useful technique is calibrating an image sensor. One type of calibration may include calibrating the selection of sub-pixels so that one image sensor can have a variety of active image area selection configurations. One method for calibrating the selection of sub-pixels may comprise illuminating the image sensor face with a desired image (e.g., a linear bar of light), reading out image information from all the sub-pixels, extracting the captured image data, and programming the image sensor selectors to select the sub-pixels that are aligned most closely with the position of the desired image.

Another type of calibration may include calibrating for background conditions of an image capture field (e.g., ambient light, infrared light, sunlight). One method for doing so may comprise periodically taking background condition measurements, determining differences between the background condition measurements and image capture data, and processing image capture data to compensate for the background conditions.

Instead of mechanical types of calibration, these electronic types of calibration may be performed independent of the mechanical aspects of an image sensor. For example, the physical position of an image sensor does not have to be altered or tested. Instead, the image sensor may be calibrated by different electronic programming. Additionally, mechanical types of calibration may be used in combination with these electronic types of calibration.

Also, these electronic types of calibration may be performed repeatedly and in various combinations to accommodate various conditions. For instance, calibration may be performed in between image captures; with and without an input image to capture; during non-usage and usage; with and without background light; and with different desired image locations, shapes, and sizes.

Additionally, another useful technique is determining when re-calibration is needed. For example, when image capture data indicates an unexpected image capture, re-calibration may be needed. For instance, when an input light is on and no light is indicated in the image capture data, re-calibration may be needed. In such a situation, image information from all the sub-pixels may be re-read as part of the re-calibration.

FIG. 4B illustrates some variations in active image area selection configurations using six variable selection groups according to embodiments of the invention. Configuration 412 shows a straight line of one row of sub-pixels.

One variation is varying the height of a selection subgroup of sub-pixels. Configuration 414 shows a tall, straight line of three adjacent, binned rows of sub-pixels. Configuration 416 shows line segments with varying heights in each variable selection group, according to the following arrangement of heights in terms of sub-pixels: 1, 3, 7, 5, 1, 3.

Another variation is varying position of a selection subgroup of sub-pixels. Configuration 418 shows a straight line of one row of sub-pixels, vertically shifted up with respect to the line of configuration 416. Configuration 420 shows line segments of two adjacent, binned rows of sub-pixels. The line segments have varying vertical positions, arranged like an angled line. Configuration 422 shows line segments of three adjacent, binned rows of sub-pixels. The line segments have varying vertical positions, arranged like a curve. Configuration 424 shows line segments of three adjacent, binned rows of sub-pixels. The line segments have varying vertical positions, arranged so that the active image area is non-continuous.

Another variation is blanking variable selection groups. Configuration 426 shows lines segments similar to configuration 424, but there are blank regions in the first, fourth, and sixth variable selection groups. In a blank variable selection group, no sub-pixels are selected.

Another variation is selecting non-adjacent sub-pixels. Configuration 428 shows lines segments similar to configuration 420, but with an additional straight line similar to configuration 418.

Another variation is varying size of a variable selection group. Configuration 430 shows six variable selection groups, each with a different size.

Any of these variations may be combined with each other. Configuration 432 shows an example of combined variations. The first, third, and fifth variable selection groups show selected sub-pixels. For varying heights, each group has selection subgroups with different heights of sub-pixels: the first group may have a segment of two adjacent, binned rows of sub-pixels; the third group may have a segment of four adjacent, binned rows of sub-pixels; and the fifth group may have a segment of one row of sub-pixels. For varying positions, each group has selection subgroups with a different position. For blanking variable selection groups, the second, fourth, and sixth groups are blank. For selecting non-adjacent sub-pixels, the first group has three non-adjacent segments of sub-pixels and the fifth group has four non-adjacent segments of sub-pixels. For varying size of a variable selection group, each of the six variable selection groups has a different size.

Readout of Image Capture Information

In the embodiment of FIGS. 3A and 3B, image capture information from the face of variable active image area imager 303 can be provided per column (i.e., pixel group). That is, as image capture information is read out from the columns, image capture information from the face is collected.

In a column, the column's sub-pixels may produce output that contains the image capture information of the column. For instance, column 330-G1-C1 may provide input 335-G1-C1 into readout 370. The other columns of variable active image area imager 303 may similarly provide corresponding input into readout 370. Readout 370 may include one or more memory elements for storing the image capture information from variable active image area imager 303.

Regardless of the number of selected rows in a column, the image capture information output by the entire column may be stored as one value. For example, in the case that only one row is selected (e.g., Row M), image capture information from just one sub-pixel (e.g., 310-G1-C1-RM) in a column (e.g., Column 1) may be stored as one value in capture circuitry (e.g., 370-G1-C1). As another example, in the case that two rows are selected, image capture information from two sub-pixels in the column may also be stored as one value in the capture circuitry. The values from multiple columns may be sampled all together at a time or sampled sequentially.

Therefore, the total number of values to process may correspond to a number of columns of the variable active image area imager 303, instead of the total number of sub-pixels in those columns. Accordingly, the image capture information from the face of variable active image area imager 303 can be processed as one row of values, not multiple rows. For instance, if readout 370 includes a shift register as a memory element for storing the image capture information of the columns, such a shift register can shift out this image capture information of the columns as one row of values, not multiple rows. In contrast, the readout process for a typical area array imager may involve reading out multiple rows of values, one row at a time, to collect all the image capture information from the face of the area array imager. Thus, variable active image area imager 303 may process much less information than a typical area array imager, resulting in lower power consumption and lower requirements for processing power.

Additionally, in some embodiments, it may be unnecessary to process image capture information from every column (i.e., pixel group) (or even from every variable selection group). Such embodiments may be practiced with selective readout, such as reading out image capture information from some columns (or from some variable selection groups) without reading out image capture information from particular columns (or even from particular variable selection groups). Such embodiments may also be practiced by reading out image capture information from every column (or from every variable selection group), discarding image capture information from particular columns (or from particular variable selection groups), and processing the remaining image capture information.

Image Capture Device

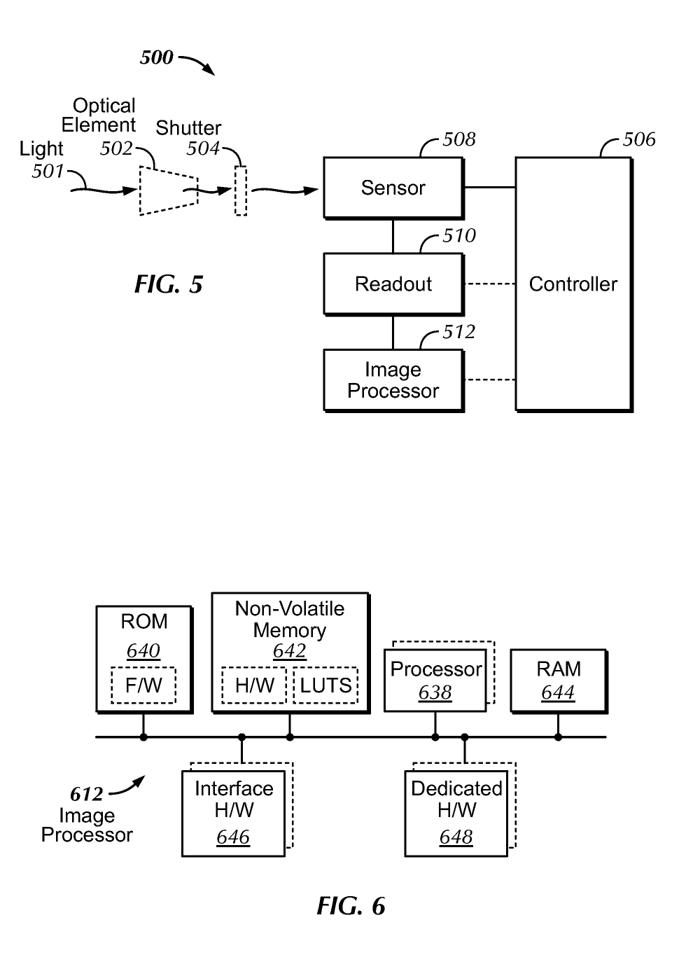

FIG. 5 illustrates an exemplary image capture device 500 including a sensor 506 (imager) according to embodiments of the invention. Light 501 can approach sensor 506 via one or more optional optical elements 502 (e.g., reflecting element, deflecting element, refracting element, propagation medium). An optional shutter 504 can control the exposure of sensor 506 to light 501.

A controller 506 can contain a computer-readable storage medium, a processor, and other logic for controlling operations of a sensor 508. As an example, controller 506 can provide control signals for performing the sub-pixel selection operations described above, such as the selecting of sub-pixels by selectors 340-G1, 340-G2, . . . , 340-GN in FIG. 3A. Sensor 508 can operate in accordance with the variable active image area image sensor teachings above. The computer-readable storage medium may be embodied in various non-transitory forms, such as physical storage media (e.g., a hard disk, an EPROM, a CD-ROM, magnetic tape, optical disks, RAM, flash memory).

In contrast to a computer-readable storage medium, the instructions for controlling operations of sensor 508 may be carried in transitory forms. An exemplary transitory form could be a transitory propagating medium, such as signals per se).

Readout logic 510 can be coupled to sensor 508 for reading out image capture information and for storing this information within an image processor 512. Image processor 512 can contain memory, a processor, and other logic for performing operations for processing the data of an image captured by sensor 508. The sensor (imager) along with the readout logic and image processor can be formed on a single imager chip.

Controller 506 may control operations of readout 510. Controller 506 may also control operations of image processor 512. Controller 506 can comprise a field-programmable gate array (FPGA) or a microcontroller.

FIG. 6 illustrates a hardware block diagram of an exemplary image processor 612 that can be used with a sensor (imager) according to embodiments of the invention. In FIG. 6, one or more processors 638 can be coupled to read-only memory 640, non-volatile read/write memory 642, and random-access memory 644, which can store boot code, BIOS, firmware, software, and any tables necessary to perform the processing described above. Optionally, one or more hardware interfaces 646 can be connected to the processor 638 and memory devices to communicate with external devices such as PCs, storage devices, and the like. Furthermore, one or more dedicated hardware blocks, engines, or state machines 648 can also be connected to the processor 638 and memory devices to perform specific processing operations.

Comparative Advantages

Embodiments of the variable active imager area image sensor may provide notable advantages over conventional image sensors. By way of example, in applications for capturing a linear aspect of an image, embodiments of the variable active imager area image sensor may be used instead of a conventional linear imager. Embodiments of the variable active image area imager can provide variable location, size, and shape of active image area, which can lead to greater flexibility in alignment and calibration considerations for the position, size, and shape of the image. Furthermore, embodiments of the variable active image area imager can provide electronic types of calibration that can repeatedly adjust to different alignment conditions, independent of mechanical methods of calibration and alignment.

In the same applications for capturing a linear aspect of an image, embodiments of the variable active imager area image sensor may be used instead of a conventional area array imager, as well. Embodiments of the variable active image area imager and a conventional linear imager may provide similar, or even the same, amounts of image information to process. Specifically, a conventional area array imager and embodiments of the variable active image area imager may similarly have two-dimensional faces. For a conventional area array imager, image information from the face may be read out from each of all the rows, one row of information at a time. Each row of information is based on information from the same row of LDEs. Each row may be chosen for readout, in a fixed or random sequence. In contrast, for embodiments of the variable active image area imager, image information from the face may be read out from all selected rows as just one row of information. Also, sub-pixel selection in the variable active image area imager may be independent of any fixed or random sequence of choosing rows that eventually progresses through many different rows for a readout process. For instance, sub-pixel selection may be based on application needs (e.g., calibration and alignment issues). Accordingly, scanning of the face can be reduced and focused on regions of interest instead of the entire face. The one row of information may be based on information from a variety of LDE row selection configurations, and some of these configurations can include information from multiple rows of LDEs or from different rows of LDEs. Thus, similar to a conventional linear imager, using a variable active image area imager may involve less processing power and lower power consumption than a conventional area array imager.

Additionally, embodiments of the variable active image area imager can select a subset of sub-pixels or a subset of image capture information produced by sub-pixels. Thus, the use of unnecessary sub-pixels or the use of unnecessary image capture information can be avoided, which can lead to less processing and lower power consumption and less image capture information with noise.

Furthermore, embodiments of the variable active image area imager can keep sub-pixels that are not selected for readout in a reset condition. This reset condition can minimize crosstalk between neighboring sub-pixels related to blooming, thus contributing to higher image quality.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. An apparatus for providing a variable active image area, the apparatus comprising:
a first plurality of sub-pixels arranged into a first variable selection group of sub-pixels, the first variable selection group including sub-pixels arranged into a pixel group A of sub-pixels, pixel group A including a plurality of sub-pixels belonging to a plurality of selection subgroups of sub-pixels;
a first selector for the first variable selection group, the first selector configured to provide variable sub-pixel selection for the first variable selection group, the selector configured to select a combination of one or more selection subgroups of first variable selection group to provide variable sub-pixel selection.

2. The apparatus of claim 1, further comprising:
pixel group A configured to output one pixel group value per combination selected by the first selector;
a readout configured to read out the one pixel group value from pixel group A.

3. The apparatus of claim 2, the one pixel group value based on a plurality of sub-pixel values generated by a plurality of sub-pixels when the combination selected by the first selector includes a plurality of selection subgroups.

4. The apparatus of claim 1, further comprising:
the first variable selection group further including sub-pixels arranged into a pixel group B of sub-pixels, pixel group B including a sub-pixel belonging to a selection subgroup of said plurality of selection subgroups.

5. The apparatus of claim 1, further comprising:
a second plurality of sub-pixels arranged into a second variable selection group of sub-pixels, the second variable selection group including sub-pixels arranged into a pixel group C of sub-pixels, pixel group C including a plurality of sub-pixels belonging to a plurality of selection subgroups of sub-pixels;
a second selector for the second variable selection group, the second selector configured to provide variable sub-pixel selection for the second variable selection group, the selector configured to select a combination of one or more selection subgroups of the second variable selection group to provide variable sub-pixel selection;
wherein the variable sub-pixel selection for the first variable selection group is independent of the variable sub-pixel selection for the second variable selection group.

6. The apparatus of claim 1, further comprising:
binning circuitry configured to bin together a plurality of sub-pixels within pixel group A.

7. The apparatus of claim 6,
the binning circuitry further including:
a sense node;
each sub-pixel of pixel group A including:
a photodetector;
a selection gate configured to connect the photodetector to the sense node.

8. The apparatus of claim 1, further comprising:
holding circuitry configured to hold in a reset condition sub-pixels that belong to a set of selection subgroups other than the one or more selection subgroups of the combination selected by the first selector.

9. The apparatus of claim 8, further comprising:
the holding circuitry further including:
a bias source;
a selection subgroup bias gate configured to connect the bias source to a selection subgroup J of said plurality of selection subgroups;
each sub-pixel belonging to selection subgroup J including:
a photodetector;
a sub-pixel bias gate configured to connect the photodetector to the bias source.

10. An image capture device comprising the apparatus of claim 1.

11. A method for providing a variable active image area, the apparatus comprising:
arranging a first plurality of sub-pixels into a first variable selection group of sub-pixels, the first variable selection group including sub-pixels arranged into a pixel group A of sub-pixels, pixel group A including a plurality of sub-pixels belonging to a plurality of selection subgroups of sub-pixels;
selecting a combination of one or more selection subgroups of the first variable selection group to provide variable sub-pixel selection for the first variable selection group.

12. The method of claim 11, further comprising:
outputting one pixel group value from pixel group A per selected combination;
reading out the one pixel group value from pixel group A.

13. The method of claim 12, the one pixel group value based on a plurality of sub-pixel values generated by a plurality of sub-pixels when the selected combination includes a plurality of selection subgroups.

14. The method of claim 11, further comprising:
the first variable selection group further including sub-pixels arranged into a pixel group B of sub-pixels, pixel group B including a sub-pixel belonging to a selection subgroup of said plurality of selection subgroups.

15. The method of claim 11, further comprising:
arranging a second plurality of sub-pixels into a second variable selection group of sub-pixels, the second variable selection group including sub-pixels arranged into a pixel group C of sub-pixels, pixel group C including a plurality of sub-pixels belonging to a plurality of selection subgroups of sub-pixels;
selecting a combination of one or more selection subgroups of the second variable selection group to provide variable sub-pixel selection for the second variable selection group;
wherein the variable sub-pixel selection for the first variable selection group is independent of the variable sub-pixel selection for the second variable selection group.

16. The method of claim 11, further comprising:
binning together a plurality of sub-pixels within pixel group A.

17. The method of claim 11, further comprising:
holding in a reset condition sub-pixels that belong to a set of selection subgroups other than the one or more selection subgroups of the selected combination.

18. A computer-readable storage medium storing instructions that, when executed by a processor, cause the processor to perform a method for an apparatus including a first plurality of sub-pixels arranged into a first variable selection group of sub-pixels, the first variable selection group including sub-pixels arranged into a pixel group A of sub-pixels, pixel group A including a plurality of sub-pixels belonging to a plurality of selection subgroups of sub-pixels, the method comprising:
selecting a combination of one or more selection subgroups of the first variable selection group to provide variable sub-pixel selection for the first variable selection group.

19. The computer-readable storage medium of claim 18, the method further comprising:
outputting one pixel group value from pixel group A per selected combination;
reading out the one pixel group value from pixel group A.

20. The computer-readable storage medium of claim 19, the one pixel group value based on a plurality of sub-pixel values generated by a plurality of sub-pixels when the selected combination includes a plurality of selection subgroups.

21. The computer-readable storage medium of claim 18, the apparatus further including a second plurality of sub-pixels arranged into a second variable selection group of sub-pixels, the second variable selection group including sub-pixels arranged into a pixel group C of sub-pixels, pixel group C including a plurality of sub-pixels belonging to a plurality of selection subgroups of sub-pixels, the method further comprising:
selecting a combination of one or more selection subgroups of the second variable selection group to provide variable sub-pixel selection for the second variable selection group;
wherein the variable sub-pixel selection for the first variable selection group is independent of the variable sub-pixel selection for the second variable selection group.

22. The computer-readable storage medium of claim 18, the method further comprising:
binning together a plurality of sub-pixels within pixel group A.

23. The computer-readable storage medium of claim 18, the method further comprising:
holding in a reset condition sub-pixels that belong to a set of selection subgroups other than the one or more selection subgroups of the selected combination.
